(19) United States
(12) Patent Application Publication
(10) Pub. No.: US 2009/0070828 A1
(43) Pub. Date: Mar. 12, 2009

(54) Method And System For Back Channel Communication For Set Top Box Devices

(76) Inventors: Ilya Stomakhin, Cupertino, CA (US); Ayman Ghobrial, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/013,976

(22) Filed: Jan. 14, 2008

Related U.S. Application Data
(60) Provisional application No. 60/971,287, filed on Sep. 11, 2007.

(51) Int. Cl. H04N 7/20; H04N 7/173

(52) U.S. Cl. 725/68; 725/133

(57) ABSTRACT

A set top box (STB) may be enabled to generate and communicate SMS messages over a back channel between the STB and one or more networked entities such as a satellite service provider headend and/or billing center via a coupled communication device. The SMS enabled communication device may be integrated within the STB or may be external to the STB. The SMS messages may comprise an address for one or more destination devices. In addition, the STB may receive acknowledgement messages for corresponding transmitted SMS messages and/or may receive and decode SMS messages. The SMS messages may be communicated via an integrated Bluetooth transceiver and an external cellular phone, via an integrated cellular transceiver and/or via a cable connecting an external cellular phone. The STB may be a satellite STB. The communicated SMS message may comprise billing information. The networked entity may comprise a headend and/or a billing center.

### CROSS-REFERENCE TO RELATED APPLICATIONS/INCORPORATION BY REFERENCE

This application makes reference to, claims priority to, and claims the benefit of U.S. Provisional Application Ser. No. 60/971,287 (Attorney Docket No. 18875US01), filed on Sep. 11, 2007, which is hereby incorporated herein by reference in its entirety.

### FIELD OF THE INVENTION

Certain embodiments of the invention relate to communication. More specifically, certain embodiments of the invention relate to a method and system for back channel communication for set top box devices.

### BACKGROUND OF THE INVENTION

Consumers may utilize set top boxes to receive multimedia content from a service provider via cable or via wireless satellite transmissions. The received multimedia content may be processed within the set top box (STB) and sent to an audio/video display for viewing or sent to a storage device for example. Service providers that rely on satellite communications for delivery of multimedia content may transmit information on a forward link from the service provider to the consumer. However, the satellite service provider may not receive information back from the consumer via the same wireless satellite communications path and may require an alternative means for communication. A communications path directed from the consumer to the service provider may be referred to as the reverse link or a “back channel”. A back channel may be utilized to communicate operational or service related information such as pay-per-view and may comprise a forward and reverse link. For example, current satellite television STBs rely on landline connections to communicate billing and other record keeping information to and from a satellite TV service provider's billing center. This communication link is called a back channel. Current satellite STBs use analog modems over landlines for back channel communications.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and system for back channel communication for set top box devices, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary communication system comprising a satellite set top box (STB) enabled to engage in short message service (SMS) back channel communication, in accordance with an embodiment of the invention.

FIG. 1B is a block diagram of an exemplary STB enabled to communicate SMS messages via an integrated wireless transceiver and a cellular phone, in accordance with an embodiment of the invention.

FIG. 1C is a block diagram of an exemplary STB enabled to communicate SMS messages via an integrated cellular transceiver, in accordance with an embodiment of the invention.

FIG. 2A is a block diagram of an exemplary back channel portion of an STB configured to transmit and/or receive SMS messages via an integrated wireless transceiver, in accordance with an embodiment of the invention.

FIG. 2B is a block diagram of an exemplary back channel portion of an STB configured to transmit and/or receive SMS messages via a wireless transceiver plug-in card, in accordance with an embodiment of the invention.

FIG. 3 is a flow chart illustrating exemplary steps for sending and receiving SMS messages to and/or from a STB, in accordance with an embodiment of the invention.

### DETAILED DESCRIPTION OF THE INVENTION

Certain aspects of the invention may be found in a method and system for back channel communication for set top box (STB) devices. For example the STB may be utilized for communication with a satellite service provider. The back channel communication or links may utilize short message service (SMS) messages between a consumer's STB and networked entities via wireless and/or landline paths. The networked entities and/or networked services may comprise, for example and without limitation, a satellite service provider's headend and/or its billing center. In this regard, one or more of a plurality of wireless transceivers may be integrated within an STB. For example, an integrated cellular transceiver may be enabled to establish the back channel link to networked entities via a cellular network. In another exemplary embodiment of the invention, a Bluetooth transceiver may be integrated within the STB and may be enabled to establish a wireless link to a cellular phone located within operating range of the STB. The cellular phone may enable the back channel link to the networked entities via the cellular network. Accordingly, back channel SMS messages may be transmitted and/or received by the STB via a wireless link such as the Bluetooth link, the cellular link and/or one or more other network links, for example the internet. SMS messages may be received and forwarded via an SMS gateway within the networked entities. Acknowledgement of receipt of SMS messages as well as other messages may be received by the STB from one or more networked entities. The invention is not limited to any specific STB integrated transceiver and may comprise other suitable transceivers such as WLAN (802.11) or infrared or may comprise a cable connection wherein for example, a USB cable may be connected between the STB and the cellular phone to enable the backchannel. Back channel communication enabled by the invention may be utilized for a plurality of services and operations. For example, information for billing purposes, such as for pay-per-view or other services may be communicated. In addition, communication of operations, administration, maintenance, and provisioning (OAMP) information such as software administration, alarming, performance reports and configuration parameters may be enabled. In some embodiments of the invention, the STB may comprise a GPS receiver and the back channel may be utilized for communicating location and/or timing information.

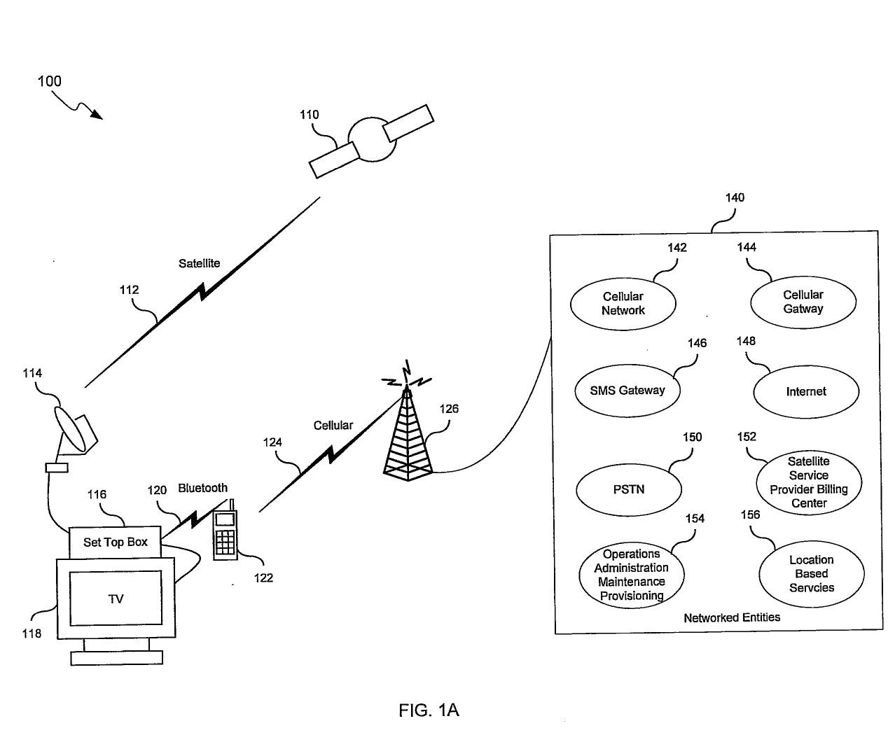

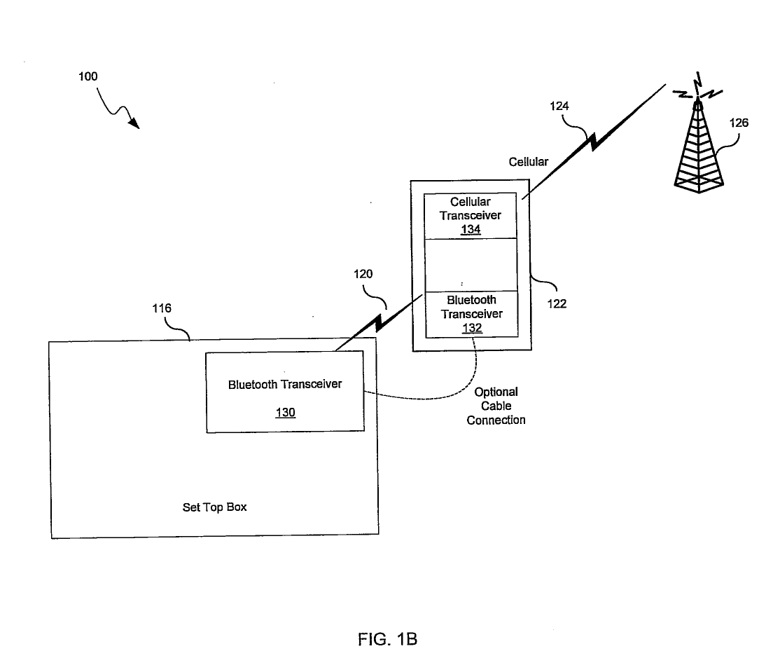

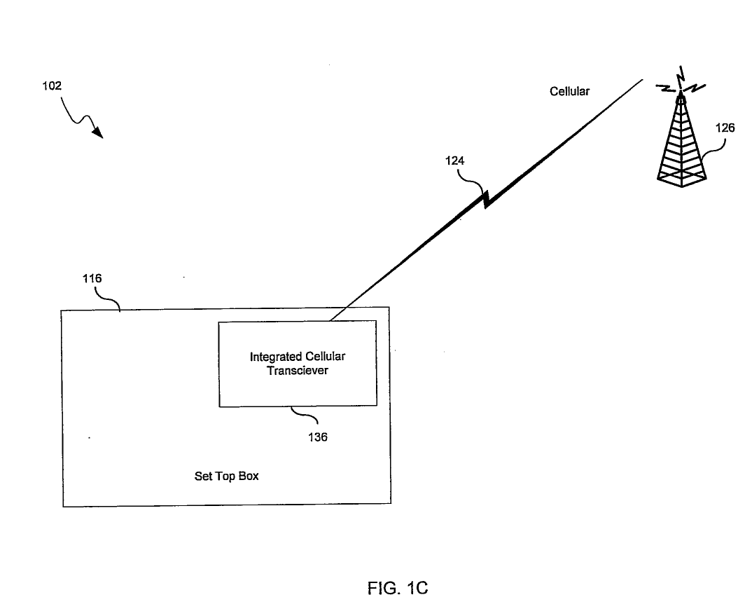

FIG. 1A is a block diagram of an exemplary communication system comprising a satellite set top box (STB) enabled to engage in short message service (SMS) back channel communication, in accordance with an embodiment of the invention. Referring to FIG. 1A, there is shown an exemplary communications system 100 that may comprise a communications satellite 110, a satellite signal 112, a parabolic receiving dish 114, a set top box (STB) 116, an audio/video display 118, a Bluetooth signal 120, a cellular phone 122, a cellular signal 124, a base station 126, networked entities 140, a cellular network 142, a cellular gateway 144, an SMS gateway 146, the internet 148, the public switched telephone network (PSTN) 150, a satellite service provider billing center 152, an operations, administration, maintenance and provisioning (OAMP) block 154 and a location based services node 156.

The communications satellite 110 may be utilized to deliver television signals to consumers and/or cable television providers for example. The communications satellite 110 may receive transmissions from an uplink facility via a transponder and may broadcast the satellite signal 112 to one or more terrestrial satellite dishes such as the parabolic receiving dish 114 for example.

The set top box (STB) 116 may comprise suitable logic, circuitry and/or code to receive the satellite signal 112 that may comprise audio/video data. In addition, the STB 116 may process and/or decode the audio/video data and may forward an audio/video data stream to the audio/video display 118 for example. Moreover, the STB 116 may comprise suitable logic, circuitry and/or code to send and/or receive short message service (SMS) messages via a wireless link such as the Bluetooth signal 120 for example to the cell phone 122. The STB 116 may be communicatively coupled with the parabolic receiving dish 114, the audio/video display 118 and a cellular phone 112.

The cellular phone 112 may comprise suitable logic, circuitry and or code to send and receive message such as SMS messages to and/or from the STB 116 via the Bluetooth signal 120 as well as send and receive messages such as SMS messages via the cellular signal 124 and base station 126 to and/or from the cellular network 142. The cellular phone 112 may communicate via any suitable frequency and/or wireless technology that may handle SMS message delivery.

The networked entities 140 may comprise a cellular network 142 that may handle traffic to and from the base station 126. The cellular network 142 may be communicatively coupled to a plurality of networked entities and/or networked services. For example, the cellular network 142 may be communicatively coupled to the public switched telephone network (PSTN) 150 and/or to the Internet 148 via the cellular gateway 144. The PSTN 150 and/or the Internet may enable message delivery to other services and/or networked entities such as the satellite service provider's head-end which may comprise the satellite service provider's billing center 152. In some embodiments of the invention, the satellite service provider's billing center 152 may be a separate networked entity within the networked entities 140. In addition, the networked entities 140 may comprise an SMS gateway 146 that may be communicatively coupled with one or more service providers' SMS message centers, for example, SMS messages may be delivered to the satellite service provider's billing center 152, the OAMP block 154 and/or to the location based services node 156, for example. In an exemplary embodiment of the invention, the SMS messages may be delivered to a destination based on an address such as an IP address or a MAC address, or a directory number (DN) such as a telephone number via a cellular phone, a landline phone, an email service and/or web service. The SMS gateway 146 may be enabled to send an acknowledgement of a received SMS message to the source of the message, for example the STB 116. Networked entities available to send and/or receive the SMS messages to and/or from the STB 116 are not limited to the entities described in networked entities 140 and may comprise any entity or combination of entities enabled to receive and handle messages from the STB 116.

In operation, the STB 116 may determine when to send a message such as an SMS message, based on one or more of a plurality of triggering events. For example, the STB may receive a request via the forward satellite signal 112, the networked entities 140 and/or may utilize an internal periodic schedule. In this regard, the STB 116 may establish a Bluetooth connection with the cellular phone 122 via the Bluetooth signal 120. The STB 116 may generate an SMS message comprising a destination address. The STB 116 may send the generated SMS message via the Bluetooth signal 120 to the cellular phone 122. The cellular phone 122 may forward the received SMS message to the cellular network 142 via the cellular signal 124 and the base station 126. The cellular network 142 may forward the SMS message to the SMS gateway 146. The SMS gateway 146 may forward the SMS message from the STB 116 to the satellite service provider billing center 152 via the Internet 148 for example. In addition, the SMS gateway 146 may send an acknowledgement message back to the STB 116 via the cellular network 142, cellular phone 122 and the Bluetooth signal 120. The STB 116 may receive the acknowledgement message that may be an SMS message. Moreover, the billing center 152 may reply to the STB 116 via an SMS message for example.

FIG. 1B is a block diagram of an exemplary STB enabled to communicate SMS messages via an integrated wireless transceiver and a cellular phone, in accordance with an embodiment of the invention. Referring to FIG. 1B, there is shown a portion of the system 100 from FIG. 1A comprising a set top box (STB) 116, a wireless transceiver 130, a wireless signal 120, a cellular phone 122, a wireless transceiver 132, a cellular transceiver 134, a cellular signal 124 and a base station 126.

The STB 116, wireless signal 120, cellular phone 122, cellular signal 124 and base station 126 may be similar to or substantially the same as the respective figure elements shown in FIG. 1A.

The STB 116 may comprise one or more integrated transceivers such as the wireless transceiver 130. The wireless transceiver 130 may be enabled to transmit and/or receive messages such as SMS messages via the wireless signal 120 to one or more wireless devices such as the cellular phone 122 comprising the wireless transceiver 132. The invention is not limited in regard to type of transceiver utilized to convey an SMS message. For example the wireless transceivers 130 and 132 may be Bluetooth, Zigbee, wireless local area network (WLAN), cellular and/or infrared (IR) and may be utilized to convey a message such as a DTMF message. In instances where the wireless transceivers 130 and/or 132 are Bluetooth, the corresponding wireless signal 120 may be a Bluetooth signal. In instances where the wireless transceivers 130 and/or 132 are Zigbee, the corresponding wireless signal 120 may be a Zigbee signal. In instances where the wireless transceivers 130 and/or 132 are WLAN, the corresponding wireless signal 120 may be a WLAN signal. In instances where the wireless transceivers 130 and/or 132 are cellular, the corresponding wireless signal 120 may be a cellular signal. In instances where the wireless transceivers 130 and/or 132 are IR, the corresponding wireless signal 120 may be an IR signal. In addition, a cable such as a USB cable may be connected between the cellular phone 122 and the STB 116 to carry signals comprising for example SMS messages.

The cellular phone 122 may comprise a plurality of wireless transceivers for example, the wireless transceiver 132 and the cellular transceiver 134. In this regard, the cellular phone 122 may be enabled to transmit and/or receive messages such as SMS messages to and/or from the STB 116 as well as sending and receiving messages via the cellular transceiver 134 and cellular signal 124 to the base station 126.

In operation, the STB 116 may establish a wireless connection with the cellular phone 122. The STB 116 may generate an SMS message comprising a destination address within the networked entities 140 as shown in FIG. 1A. The STB 116 may send the generated SMS message to the cellular phone 122 via the wireless transceiver 130, the wireless signal 120 and the wireless transceiver 132. The cellular phone 122 may forward the received SMS message to the cellular base station 126 via the cellular transceiver 134 and cellular signal 124. In addition, the STB 116 may receive a plurality of messages via the wireless transceiver 130, which may comprise, for example, acknowledgement messages, replies to messages sent from the STB 116, and/or messages from a networked service provider for example, requests for information, coded instructions and/or application data.

FIG. 1C is a block diagram of an exemplary STB enabled to communicate SMS messages via an integrated cellular transceiver, in accordance with an embodiment of the invention. Referring to FIG. 1C, there is shown a system 102 comprising a set top box (STB) 116, an integrated cellular transceiver 136, a cellular signal 124 and a base station 126.

The STB 116, cellular signal 124 and base station 126 may be similar or substantially the same as the respective figure elements shown in FIGS. 1A and 1B.

The STB 116 integrated cellular transceiver 136 may comprise suitable logic, circuitry and/or code that may be enabled to send and/or receive messages such as SMS messages to and/or from the cellular base station 126 and/or the networked entities 140 described in FIG. 1A for example. In this regard, an intermediate communication device such as the cellular phone 122 comprising a Bluetooth transceiver 130 described in FIGS. 1A and 1B may not be needed. The integrated cellular transceiver 136 may communicate directly with the base station 126 via any suitable frequency and/or wireless technology that may handle SMS message delivery.

In operation, the STB 116 may generate an SMS message comprising a destination address for one or more of the networked entities 140 described in FIG. 1A. The destination address may be an internet protocol (IP) address, MAC address, directory number, or phone number, for example. The STB 116 may establish communications with the base station 126 via the cellular transceiver 136 and the cellular signal 124. The STB 116 may transmit the generated SMS message to the cellular base station 126 via the cellular transceiver 136 and the cellular signal 124. In addition, the STB 116 may receive one or more of a plurality of messages via the cellular transceiver 136 that may comprise for example acknowledgement messages, replies to messages sent from the STB 116, and/or messages from a networked service provider for example, requests for information, coded instructions and/or application data.

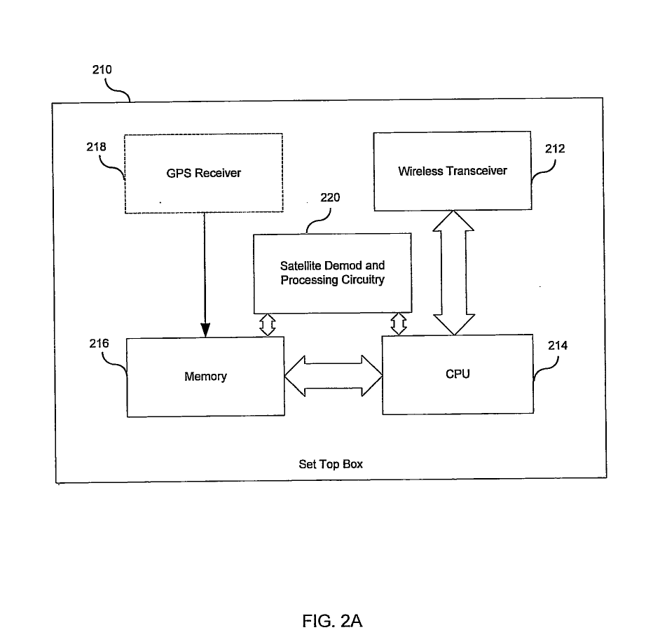

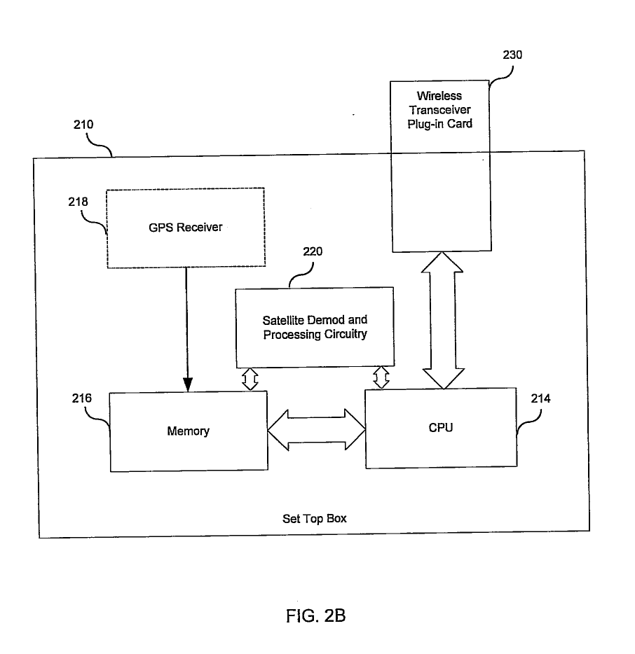

FIG. 2A is a block diagram of an exemplary back channel portion of an STB configured to transmit and/or receive SMS messages via an integrated wireless transceiver, in accordance with an embodiment of the invention. Referring to FIG. 2A, there is shown a set top box (STB) 210 that may comprise a wireless transceiver 212, a CPU 214, a memory 216, an optional GPS receiver 218 and a satellite demodulation and signal processing circuit 220.

The set top box (STB) 210 may be similar and/or substantially the same as the STB 116 described in FIGS. 1A, 1B and/or 1C. The STB 210 may be enabled to communicate via messages such as SMS messages to and/or from one or more networked entities 140, for example, via one or more wireless transceivers such as the wireless transceiver 212. The STB 210 may generate and or interpret received messages such as SMS messages within the CPU 214. The messages such as SMS messages may comprise billing and/or other data. In some embodiments of the invention, the STB 210 may comprise a global positioning (GPS) receiver and may communicate location information via back channel messages such as SMS messages with one or more networked entities 140. Moreover, security operations for the STP 116 may be enabled via back channel messages such as SMS messages.

The wireless transceiver 212 may comprise suitable logic, circuitry and/or code to enable communication of messages such as SMS messages to and/or from one or more networked entities 140. The wireless transceiver 212 may be integrated within the STB 210. The wireless transceiver 212 may comprise any wireless technology and may utilize any suitable frequency for transmission of wireless signals. For example, the wireless transceiver 212 may enable wireless and/or cabled personal area network (WPAN and/or PAN) communications such as Bluetooth, wireless local area network (WLAN) communications and/or wide area network communications such as cellular communications. In some embodiments of the invention, the STB 210 may be enabled to connect to a intermediary wireless device such as a cellular phone via a cable such as a USB cable for example. The wireless transceiver 212 may be enabled to communicate directly with a base station or may communicate with a base station via an intermediary device such as a cellular phone. In this regard, the cellular phone and STB 210 may communicate via a WPAN or Bluetooth connection for example.

The CPU 214 may comprise suitable logic, circuitry and/or code to establish, monitor and/or control sending and/or receiving messages such as SMS messages to and/or from one or more networked entities 140 such as with the satellite service provider billing center 152 described in FIG. 1A. In this regard, the CPU 214 may run a driver for the wireless transceiver device 212. For example, a firmware driver for a Bluetooth transceiver may be executed by the CPU 214. In addition, software applications for establishing, monitoring and/or controlling the messages such as SMS messages may executed by the CPU 212.

The memory 216 may comprise suitable logic, circuitry and/or code to enable sending and/or receiving messages such as SMS messages to and/or from one or more networked entities 140 such as with the satellite service provider billing center 152 described in FIG. 1A. Accordingly, the memory 216 may store instructions and/or data utilized and/or generated by the CPU 212. For example, the memory 216 may enable storage of addressing information for SMS messaging and/or instructions and/or processes for generating, monitoring and/or controlling messages such as SMS messages. Furthermore, the memory 216 may enable storage of service provider and/or subscriber information such as information based on billing and/or service requests.

The optional GPS receiver 218 may comprise suitable logic, circuitry and/or code that may be enabled to receive GPS data from one or more GPS satellites and may be enabled to determine the device 210's position from the received GPS data. For example the GPS receiver 218 may determine device 210's position based on ephemeris, signal delay and/or satellite position. Moreover, other sources of location or timing information may be utilized to determine the location of the device. For example, user input or input from another position or time referencing system may be utilized. In some embodiments of the invention, location information may be sent to one or more networked entities such as the location based services 156 described in FIG. 1A, via back channel messages such as SMS messages. In this regard, the STB 210 determined location and/or timing information may be sent to the networked entities 140. Furthermore, raw information data such as data received from GPS satellites and/or GPS signal measurements taken by the STB 210 may be sent to, for example, the location based services 156 and the location based services 156 may determine the location of the STB 210.

The satellite demodulation and signal processing circuit 220 may comprise suitable logic, circuitry and/or code to receive and process video signals from the communications satellite 110 via the parabolic receiving dish 114. In this regard, the video signal processing may comprise descrambling, decoding and/or various security operations for example. Received and processed video signals may be forwarded to the audio/video display 118.

In operation, the STB 210 may receive a request for transmission of information from an external entity such as a satellite service provider and/or a subscriber for example. In some embodiments of the invention, the STB 210 may determine to transmit information based on instructions and/or data stored within memory 216, for example. Accordingly, the STB 210 may generate a back channel message such as an SMS message comprising a destination address to, for example, the satellite service provider billing center 152 within the networked entities 140 described in FIG. 1A. The STB 210 may establish a wireless connection such as a Bluetooth connection via the wireless transceiver 212 and may transmit the generated back channel messages such as the SMS message via the wireless transceiver 212. In addition, the STB 210 may receive one or more acknowledgement messages such as SMS messages from one or more recipients of the transmitted back channel message. Moreover, the STB 210 may receive back channel messages such as SMS messages from, for example, the billing center 152 and may decode the received messages such as SMS messages within the CPU 214 and may store received billing center 152 information within the memory 216 for example.

FIG. 2B is a block diagram of an exemplary back channel portion of an STB configured to transmit and/or receive SMS messages via a wireless transceiver plug-in card, in accordance with an embodiment of the invention. Referring to FIG. 2B there is shown a set top box (STB) 210 a wireless transceiver plug-in card 230, a CPU 214, a memory 216, an optional GPS receiver 218 and a satellite demodulation and signal processing circuit 220.

The STB 210, CPU 214, memory 216, optional GPS receiver 218 and satellite demodulation and signal processing circuit 220 may be similar or substantially the same as the respective blocks shown in FIG. 2A.

The wireless transceiver plug-in card 230 may comprise suitable logic, circuitry and/or code to enable communication of messages such as SMS messages to and/or from one or more networked entities 140. The wireless transceiver plug-in card 230 may be attached or detached to the STB 210 by a user. The wireless transceiver plug-in card 230 may comprise any suitable wireless technology and may utilize any suitable frequency for transmission of wireless signals comprising SMS messages. For example, the wireless transceiver plug-in card 230 may enable WPAN and/or PAN communications such as Bluetooth, WLAN communications and/or wide area network communications such as cellular communications. The wireless transceiver plug-in card 230 may be enabled to communicate directly with a base station or may communicate with a base station via an intermediary device such as a cellular phone. In this regard, the cellular phone and STB 210 may communicate via a WPAN or Bluetooth connection for example.

In operation, the STB 210 may receive a request for transmission of information from an external entity such as a satellite service provider head-end and/or a subscriber for example. In some embodiments of the invention, the STB 210 may determine to transmit information based on instructions and/or data stored within memory 216, for example. Accordingly, the STB 210 may generate a back channel message such as an SMS message comprising a destination address to, for example, the satellite service provider billing center 152 within the networked entities 140 described in FIG. 1A. The STB 210 may establish a wireless connection such as a cellular connection via the wireless transceiver plug-in card 230 and may transmit the generated back channel messages such as the SMS message via the wireless transceiver plug-in card 230. In addition, the STB 210 may receive one or more acknowledgement messages such as SMS messages from one or more recipients of the transmitted back channel message. Moreover, the STB 210 may receive back channel messages such as SMS messages from, for example, the billing center 152 and may decode the received messages such as SMS messages within the CPU 214 and may store received billing center 152 information within the memory 216 for example.

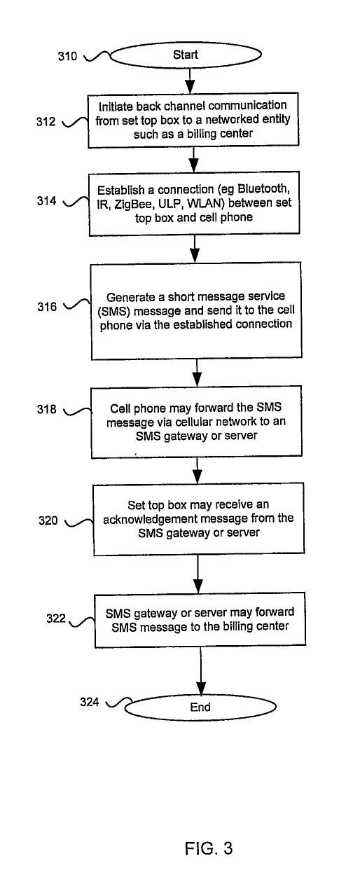

FIG. 3 is a flow chart illustrating exemplary steps for sending and receiving short message service (SMS) messages to and/or from a set top box (STB), in accordance with an embodiment of the invention. Referring to FIG. 3, after start step 310, in step 312, STB 116 or 212 may receive a request for back channel communication with a satellite service provider billing center 152 via, for example, a stored instruction or an external entity such as a satellite service provider or a subscriber. In step 314, the STB 116 or 212 may establish a wireless communication link such as a Bluetooth, WLAN, ZigBee, Infrared (IR), Ultra Low Power (ULP), connection with a cellular phone 122, for example. Optionally, a wired connection such as a USB connection may be established between the STB 116 or 212. In step 316, the STB 116 or 212 may generate an SMS message addressed to the satellite service provider billing center 152 and may transmit it to the cellular phone 122 via the Bluetooth signal 120 for example. In step 318, the cellular phone 122 may forward the SMS message to an SMS gateway or SMS server 146 via the cellular network 142. In step 320, the STB 116 or 212 may receive an acknowledgement message from the SMS gateway or SMS server 146. In step 322, the SMS gateway or server 146 may forward the SMS message to the satellite service provider billing center 152. The step 324 is the end step.

In an embodiment of the invention, a set top box (STB) 116 and/or 210 may be enabled to generate an SMS message. The STB may be enabled to communicate the SMS message over a back channel between the STB 116 and/or 210 and a networked entity, for example and without limitation, the satellite service provider billing center 152 via an SMS enabled communication device such as the cellular phone 122 that may be communicatively coupled to the STB and the networked entity. In some embodiments of the invention, the SMS enabled communication device communicatively coupled to the STB 116 and/or 210 may be integrated within the STB 116 and/or 210 and/or may be external to the STB 116 and/or 210. Accordingly, the SMS messages generated by the STB 116 and/or 210 may comprise an address for one or more destination devices such as the satellite service billing provider 152. In addition, the STB 116 and/or 210 may receive acknowledgement messages for corresponding transmitted SMS messages. Moreover, the STB 116 and/or 210 may receive and decode SMS messages. In some embodiments of the invention, the SMS messages may be communicated with the networked entity such as the satellite service billing provider 152 via an integrated Bluetooth transceiver 130 and an external cellular phone 122. In other embodiments of the invention, the SMS messages may be communicated with the network entity such as the satellite service billing provider 152 via an integrated cellular transceiver 136. Moreover, in some embodiments of the invention the SMS messages may be communicated via a cable connecting an external cellular phone 122. In this regard, the STB 116 and/or 210 may be a satellite STB and/or the communicated SMS message may comprise billing information. The networked entity may comprise a headend and/or a billing center.

Certain embodiments of the invention may comprise a machine-readable storage having stored thereon, a computer program having at least one code section for back channel communication for set top box devices, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communication, the method comprising:
generating an SMS message with a STB; and
communicating said SMS message over a back channel between said STB and a networked entity via an SMS enabled communication device communicatively coupled to said STB and said networked entity.

2. The method according to claim 1, wherein said SMS enabled communication device communicatively coupled to STB is integrated within said STB.

3. The method according to claim 1, wherein said SMS enabled communication device communicatively coupled to STB is external to said STB.

4. The method according to claim 1, comprising addressing said SMS message to a destination device.

5. The method according to claim 1, comprising receiving by said STB, an acknowledgement message for said communicated SMS message.

6. The method according to claim 1, comprising receiving and decoding an SMS message by said STB.

7. The method according to claim 1, comprising communicating by said STB, said SMS message via an integrated Bluetooth transceiver and an external cellular phone.

8. The method according to claim 1, comprising communicating said SMS message via an integrated cellular transceiver.

9. The method according to claim 1, comprising communicating said SMS message via a cable connecting an external cellular phone.

10. The method according to claim 1, wherein said STB is a satellite STB.

11. The method according to claim 1, wherein said communicated SMS message comprises billing information.

12. The method according to claim 1, wherein said networked entity comprises a headend and/or a billing center.

13. A system for communication, the system comprising:
one or more circuits comprising at least one STB circuit, operable to, at least:
generate an SMS message; and
communicate said SMS message over a back channel between an STB and a networked entity via an SMS enabled communication device communicatively coupled to said STB and said networked entity.

14. The system according to claim 13, wherein said SMS enabled communication device communicatively coupled to STB is integrated within said STB.

15. The system according to claim 13, wherein said SMS enabled communication device communicatively coupled to STB is external to said STB.

16. The system according to claim 13, wherein said one or more circuits enables addressing of said SMS message to a destination device

17. The system according to claim 13, wherein said one or more circuits enables receipt by said STB, of an acknowledgement message for said communicated SMS message.

18. The system according to claim 13, wherein said one or more circuits enables reception and decoding of SMS messages by said STB

19. The system according to claim 13, wherein said one or more circuits comprises an integrated Bluetooth transceiver and enables communication by said STB, of said SMS message via said integrated Bluetooth transceiver and an external cellular phone.

20. The system according to claim 13, wherein said one or more circuits comprises an integrated cellular transceiver and enables communication of said SMS message via said integrated cellular transceiver.

21. The system according to claim 13, wherein said one or more circuits enables communication of said SMS message via a cable connecting an external cellular phone.

22. The system according to claim 13, wherein STB is a satellite STB.

23. The system according to claim 13, wherein said communicated SMS message comprises billing information.

24. The system according to claim 13, wherein said networked entity comprises a headend and/or a billing center.

25. A machine-readable storage having stored thereon, a computer program having at least one code section for communication, the at least one code section being executable by a machine for causing the machine to perform steps comprising:
communicating short message service (SMS) messages with a networked entity via one or more transceivers integrated within a set top box.

26. The machine-readable storage according to claim 25, wherein said at least one code section comprises code that enables addressing said SMS message to a destination device, receiving by said STB, an acknowledgement message for said communicated SMS message and receiving and decoding SMS messages by said STB.

27. The machine-readable storage according to claim 25, wherein said at least one code section comprises code that enables communicating by said STB, said SMS message via one or more of an integrated Bluetooth transceiver and an external cellular phone, an integrated cellular transceiver and a cable connecting an external cellular phone.

28. The machine-readable storage according to claim 25, wherein said one or more transceivers comprises at least one wireless transceiver.
